(19) United States
(12) Patent Application Publication
(10) Pub. No.: US 2017/0269574 A1
(43) Pub. Date: Sep. 21, 2017

(54) ROBOT CONTROL DEVICE THAT CONTROLS ROBOT TO PERFORM MACHINING OPERATION, AND ROBOT PROGRAM GENERATOR

(71) Applicant: FANUC CORPORATION, Yamanashi (JP)

(72) Inventor: Tatsuya OUMI, Yamanashi (JP)

(21) Appl. No.: 15/458,184

(22) Filed: Mar. 14, 2017

(30) Foreign Application Priority Data
Mar. 17, 2016 (JP) 2016-053998

(51) Int. Cl. G05B 19/4097

(52) U.S. Cl. CPC G05B 19/4097; G05B 2219/35012

(57) ABSTRACT

A robot control device includes: a graphic primitive selection unit that selects graphic primitives having a tag indicating machining details from CAD data in a CAD device; a tool data extraction unit that extracts, from the database unit, information on a machining tool associated with the machining details indicated by the tag attached to the selected graphic primitives; and an operation planning unit that allows a robot to perform a machining operation according to the extracted information on the machining tool based on the selected graphic primitives.

### BACKGROUND OF THE INVENTION

1. Field of the Invention

The present invention relates to a robot control device that controls a robot to machine a workpiece, and a robot program generator that generates a program for operating the robot.

2.Description of the Related Art

Conventionally, when teaching an industrial robot to perform a machining operation, an operator actually moves a robot arm over predetermined points and paths with a teaching pendant or the like and stores the points and paths in a robot control unit. Alternatively, robot operation data is generated by an offline robot programming system without moving the robot. At this point, the robot performs a machining operation based on information on the machining shape of an object to be machined (Hereinafter, will be called a workpiece).

However, a workpiece drawing for indicating the machining shape of a workpiece is typically designed using a CAD device. A designer who uses the CAD device is different from a robot operator and thus cannot generate a robot program. Hence, the robot operator retrieves workpiece drawing information from the CAD device and teaches a robot to machine a workpiece at a manufacturing site based on the workpiece drawing information.

Under the circumstances, it is desired to retrieve robot control data from the workpiece drawing information with a simple operation and various methods have been proposed. For example, Japanese Patent No. 3307475 proposes a technique in which CAD data recorded on a magnetic recording disk is inputted to a personal computer by an operator, and the personal computer then converts the CAD data into operation data for a welding robot and transmits the data to a welding robot control device.

In the related art described in Japanese Patent No. 3307475, a machining tool corresponding to the machining details of a machined part is specified based on workpiece drawing information (CAD data) in a CAD device but a robot operation cannot be performed using the machining tool.

### SUMMARY OF THE INVENTION

The present invention provides a robot control device that specifies a machining tool corresponding to the machining details of a machined part based on CAD data on a workpiece drawing and controls a robot having the machining tool to perform an operation, and a robot program generator.

A first aspect of the present disclosure provides a robot control device that allows a robot to machine a workpiece based on graphic primitives indicating a machined part of an object, the graphic primitives being included in CAD data on a machining drawing of the object,

the robot control device including:

a database unit in which machining details and information on a machining tool corresponding to the machining details are stored in association with each other;

a graphic primitive selection unit that selects, from the CAD data, the graphic primitives having a tag indicating the machining details;

a tool data extraction unit that extracts, from the database unit, information on the machining tool associated with the machining details indicated by the tag attached to the graphic primitives selected by the graphic primitive selection unit; and

an operation planning unit that allows the robot to perform a machining operation according to the extracted information on the machining tool from the tool data extraction unit based on the graphic primitives selected by the graphic primitive selection unit.

According to the robot control device of the first aspect, a second aspect of the present disclosure provides a robot control device further including a CAD device that is connected so as to communicate with the robot control device and creates and stores the CAD data on the machining drawing of the object, the CAD device including a machining details input unit that attaches the tag indicating the machining details to the graphic primitives indicating the machined part of the object.

According to the robot control device of the first or second aspect, a third aspect of the present disclosure provides a robot control device in which the information on the machining tool includes a machining tool type corresponding to the machining details and restrictive conditions including at least one of a relative velocity, a position, and an orientation of the machining tool relative to the machined part.

A fourth aspect of the present disclosure provides a robot program generator that allows a robot to machine an object based on graphic primitives indicating a machined part of the object, the graphic primitives being included in CAD data on a machining drawing of the object,

the robot program generator including:

a database unit in which machining details and information on a machining tool corresponding to the machining details are stored in association with each other;

a graphic primitive selection unit that selects, from the CAD data, the graphic primitives having a tag indicating the machining details;

a tool data extraction unit that extracts, from the database unit, information on the machining tool associated with the machining details indicated by the tag attached to the graphic primitives selected by the graphic primitive selection unit; and

an operation planning unit that allows the robot to perform a machining operation according to the extracted information on the machining tool from the tool data extraction unit based on the graphic primitives selected by the graphic primitive selection unit.

A fifth aspect of the present disclosure provides a robot program generator further including a CAD device that is connected so as to communicate with the robot program generator and creates and stores the CAD data on the machining drawing of the object, the CAD device including a machining details input unit that attaches the tag indicating the machining details to the graphic primitives indicating the machined part of the object.

A sixth aspect of the present disclosure provides a robot program generator in which the information on the machine tool includes a machining tool type corresponding to the machining details and restrictive conditions including at least one of a relative velocity, a position, and an orientation of the machining tool relative to the machined part.

### BRIEF DESCRIPTION OF THE DRAWINGS

A detailed description of a typical embodiment of the present disclosure shown in the accompanying drawings further clarifies the object, characteristics, and advantages of the present invention and other objects, characteristics, and advantages of the present invention.

FIG. 1 is a block diagram schematically showing a robot control system according to an embodiment; and

FIG. 2 is a flowchart showing the operation of the robot control system shown in FIG. 1.

### DETAILED DESCRIPTION

An embodiment of the present disclosure will be described below with reference to the accompanying drawings. In the drawings, the same members are indicated by the same reference numerals. Constituent elements indicated by the same reference numerals in different drawings have the same functions. Moreover, the scale of the drawings is optionally changed to enhance understanding.

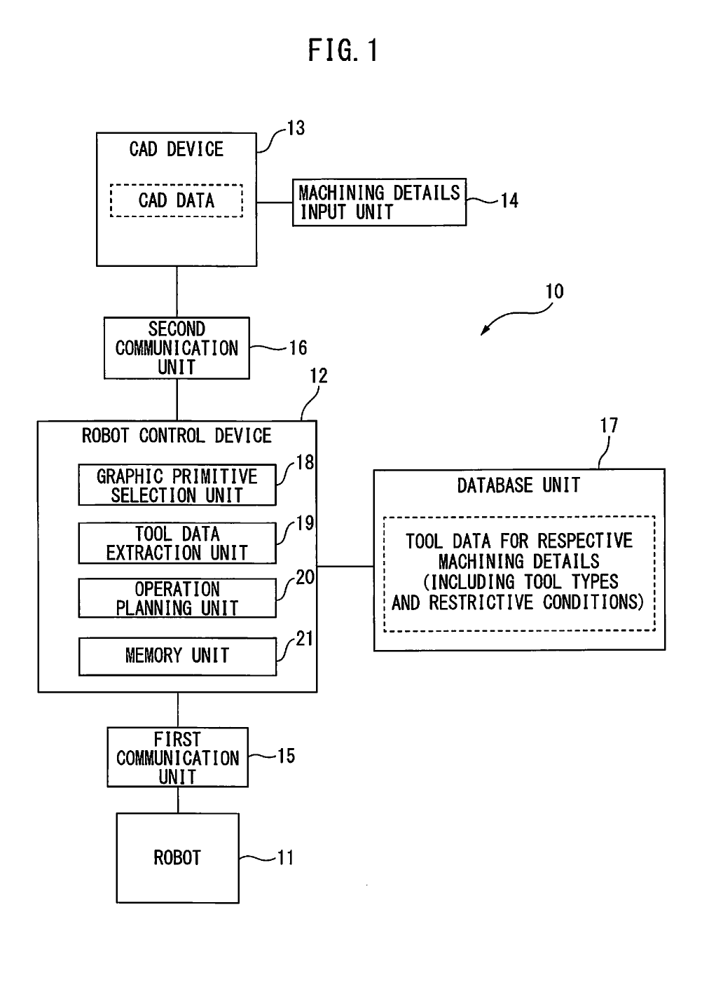

FIG. 1 is a block diagram schematically showing a robot control system according to an embodiment.

As shown in FIG. 1, a robot control system 10 according to the present embodiment includes a robot control device 12 that controls at least one robot 11 and a CAD (computer-aided design) device 13.

The robot 11 is, for example, a vertical articulated type robot that has a detachable machining tool mounted on the distal end of an arm of the robot. The machining tool is, for example, a welding torch, a welding gun, a sealant filling nozzle, a deburring tool, a drill, or an end mill. The robot 11 machines a workpiece by operating the machining tool while moving an arm part in response to an operation command from the robot control device 12. The robot 11 has a memory such as a ROM and RAM, a CPU, and a communication control unit (not shown). The communication control unit controls the exchange of data with the robot control device 12.

The CAD device 13 can support a designer in the creation of a workpiece machining drawing on a computer screen and store CAD data on the created machining drawing in an internal memory. The CAD device 13 further includes a machining details input unit 14 that inputs a tag (additional information), which indicates machining details, to graphic primitives created on the computer screen so as to indicate a machined part of a workpiece. For example, the machining details input unit 14 allows a designer to attach a tag, which indicates the machining details of a machined part, to graphic primitives indicating the machined part. The machining details to be tagged include, for example, instructions for welding methods, e.g., “arc welding” or “spot welding” and machining instructions such as “no burrs.” Specifically, machining details including a machining method, notes, and machining symbols compliant with the Japanese Industrial Standards are added with leader lines to a machined part of an illustrated workpiece. The tag indicates an expression on the leader line.

In the present embodiment, the robot 11 is disposed in a factory for manufacturing products, whereas the robot control device 12 is preferably disposed in a building next to the factory and the CAD device 13 is preferably disposed in an office remote from the factory. In this case, the robot 11 can be connected to the robot control device 12 via a first communication unit 15, e.g., an intranet network. The CAD device 13 can be connected to the robot control device 12 via a second communication unit 16, e.g., a network of the Internet. The first and second communication units 15 and 16 are merely exemplary and thus may be any kinds of communication units.

The robot control device 12 is configured to control at least one robot 11. The robot control device 12 of the present embodiment can particularly read CAD data on workpiece machining drawings stored in the CAD device 13, in response to an external instruction of the robot control device 12. The reading instruction is preferably provided by a person in a different building from the factory containing the robot control device 12 or a host computer (not shown) connected to the robot control device 12.

Moreover, the robot control device 12 of the present embodiment allows the robot 11 having the machining tool to perform a machining operation based on the CAD data on the workpiece machining drawings read internally of the CAD device 13.

More specifically, as shown in FIG. 1, the robot control device 12 includes a database unit 17, a graphic primitive selection unit 18, a tool data extraction unit 19, an operation planning unit 20, and a memory unit 21. The database unit 17, as shown in FIG. 1, is disposed as an external storage device outside the robot control device 12 via a wireless or wired communication unit. The database unit 17 may be provided in the robot control device 12.

The database unit 17 stores kinds of machining details and information on machining tools (Hereinafter, will be called tool data) corresponding to the respective kinds of machining details such that the machining details and the machining tool information are associated with each other. The machining details include, for example, arc welding, spot welding, sealing, and deburring. In this case, the machining tools corresponding to the respective machining details include a welding torch, a welding gun, a sealant filling nozzle, and a deburring tool. The tool data also includes the dimensions of the machining tools and restrictive conditions including at least one of a relative velocity, a position, and an orientation of the machining tool relative to a machined part.

The graphic primitive selection unit 18 selects the graphic primitives of a machined part of a workpiece with a tag indicating the machining details, from the CAD data on the workpiece machining drawings. The tool data extraction unit 19 extracts, from the database unit 17, tool data associated with the machining details that are indicated by the tag attached to the graphic primitives selected by the graphic primitive selection unit 18.

The tool data to be extracted includes the kind and dimensions of a machining tool corresponding to the machining details indicated by the tag, and the restrictive conditions of the machining tools. Specifically, the tool data extraction unit 19 specifies a machining tool corresponding to the machining details of a machined part of a workpiece; meanwhile, the tool data extraction unit 19 obtains the dimensions of the machining tool and the restrictive conditions including at least one of a relative velocity, a position, and an orientation of the machining tool relative to the machined part.

The operation planning unit 20 allows the robot 11 to perform a machining operation using the tool data extracted by the tool data extraction unit 19, that is, the specified machining tool and the restrictive conditions based on the graphic primitives selected by the graphic primitive selection unit 18.

Alternatively, the operation planning unit 20 may store the machining operation as a robot program in the memory unit 21 without performing the machining operation of the robot 11. In this case, for example, only simulation is performed but an immediate actual operation is not necessary. Thus, the robot control device 12 of the present embodiment can also act as a robot program generator that generates a robot program allowing the robot 11 to perform a machining operation.

The robot control device 12 may be configured using a computer system including a storage unit, a CPU (control processing unit), and a communication unit that are connected to one another via a bus. The storage unit is, for example, a ROM (read only memory) or a RAM (random access memory). Furthermore, programs stored in a ROM are executed by a CPU so as to obtain the functions and operations of the graphic primitive selection unit 18, the tool data extraction unit 19, and the operation planning unit 20 that are provided in the robot control device 12.

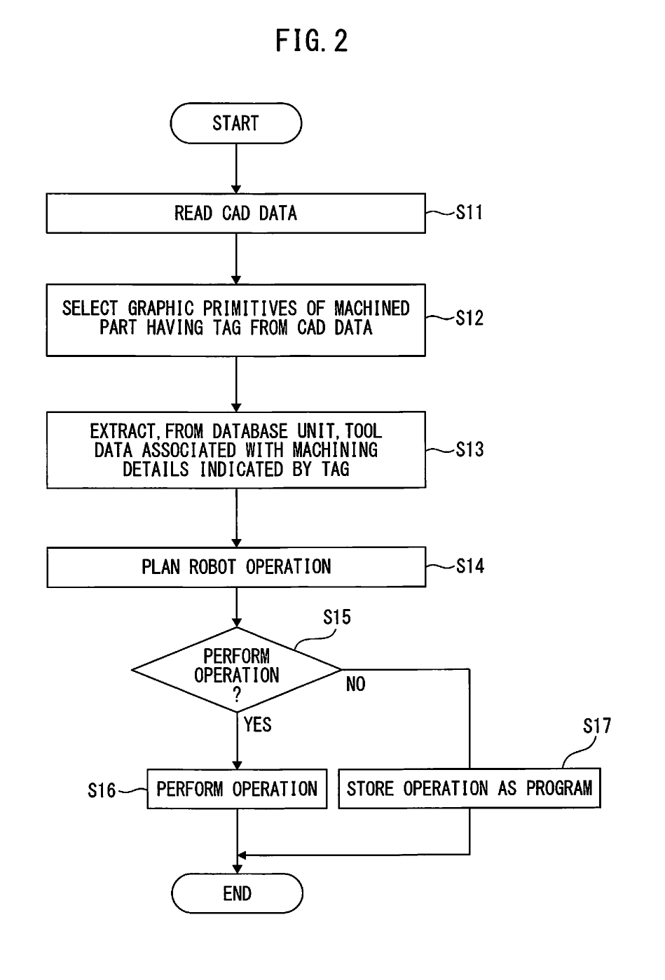

FIG. 2 is a flowchart showing the operation of the robot control device 12 according to the present embodiment. Referring to FIG. 2, the operation of the robot control device 12 in FIG. 1 will be described below.

In step S11 of FIG. 2, a designer creates a workpiece machining drawing by using the CAD device 13, and then data (CAD data) on the created machining drawing is stored in the internal memory of the CAD device 13. In the database unit 17 of the robot control device 12, kinds of machining details and information (tool data) on the machining tools corresponding to the machining details are stored in association with each other.

Furthermore, a tag (additional information) indicating the machining details of a machined part is attached to graphic primitives indicating a machined part of a workpiece. The graphic primitives are created on the computer screen of the CAD device 13. The CAD data on the graphic primitives indicating the machined part includes the dimension values of the sides and corners of the machined part, for example, a side length, a corner angle, and a radius of curvature.

First, in step S11, the robot control device 12 reads CAD data on a workpiece machining drawing from the CAD device 13.

Subsequently, in step S12, the graphic primitive selection unit 18 of the robot control device 12 selects, from the CAD data on the workpiece machining drawing, the graphic primitives of a machined part of a workpiece with a tag indicating machining details.

In step S13, the tool data extraction unit 19 of the robot control device 12 extracts, from the database unit 17, tool data associated with the machining details indicated by the tag attached to the graphic primitives of the machined part, the graphic primitives being selected by the graphic primitive selection unit 18.

In step S14, the operation planning unit 20 plans a machining operation of the robot 11 according to the tool data extracted by the tool data extraction unit 19, based on the selected graphic primitives of the machined part from the graphic primitive selection unit 18.

Specifically, from the selected graphic primitives of the machined part of the workpiece from the CAD data, the operation planning unit 20 extracts the dimension values of the machined part, the dimension values being included in the graphic primitives. Moreover, on the assumption that the machining tool of the tool data extracted by the tool data extraction unit 19 is mounted on the arm part of the robot 11, the operation planning unit 20 plans the motion path of the machining tool based on the extracted dimension values of the machined part. During planning, the dimensions of the machining tool and restrictive conditions, including a relative velocity, a position, and an orientation of the machining tool relative to the machined part, are also taken into consideration. Thus, the operation planning unit 20 allows an operation of the robot 11, on which the machining tool corresponding to the machining details of the machined part is actually mounted, according to the planned motion path of the machining tool. The motion path of the machining tool is planned on the assumption that a workpiece is fixed at a predetermined position (coordinates) in the world frame of the robot 11.

If the workpiece has a plurality of machined parts, the motion path of the machining tool is preferably planned so as to minimize a motion path between the machining parts.

Subsequently, in step S15, it is determined whether or not to perform a machining operation planned for the robot 11 by the operation planning unit 20. An instruction for performing the machining operation is provided by, for example, a person in a different building from a factory containing the robot control device 12, or a host computer (not shown) connected to the robot control device 12.

In step S15, if it is determined that an instruction for performing the machining operation of the robot 11 has been provided, the process advances to step S16 and the operation planning unit 20 performs the planned machining operation of the robot 11.

In step S15, if it is determined that an instruction for performing the machining operation of the robot 11 has not been provided, the process advances to step S17 and the operation planning unit 20 stores the planned machining operation of the robot 11 as a robot program in the memory unit 21.

As described above, in the robot control device 12 of the present embodiment, the graphic primitives of a machined part are selected with a tag indicating the machining details of a workpiece, from stored CAD data on a workpiece machining drawing in the CAD device 13. Subsequently, information on the machining tool corresponding to the machining details indicated by the tag, which is attached to the selected graphic primitives, is automatically extracted from the database unit 17. The robot control device 12 then performs the machining operation of the robot 11 according to the extracted information on the machining tool based on the selected graphic primitives. Alternatively, the robot control device 12 generates a robot program for performing the machining operation.

Thus, according to the present embodiment, a machining tool corresponding to the machining details of a machined part can be specified based on workpiece drawing information (CAD data) in the CAD device, allowing the machining operation of the robot 11 having the machining tool. Furthermore, a robot program for performing the machining operation can be generated.

Moreover, according to the present embodiment, even if machining details vary among the machined parts of a workpiece, the machining operation of the robot 11 can be planned according to tool data including the kinds, dimensions, and restrictive conditions of machining tools corresponding to the machining details.

According to the present embodiment, the CAD device 13 and the database unit 17 are connected so as to communicate with the robot control device 12. Thus, even if the locations of the CAD device 13 and the database unit 17 are remote from the robot control device 12, the robot control device 12 can directly obtain CAD data on a workpiece machining drawing and information on a machining tool corresponding to the machining details of a machined part of a workpiece.

Furthermore, according to the present embodiment, the machining operation of the robot 11 can be simulated without preparing a workpiece or a machining tool for the robot 11, as in actual machining on a workpiece by the robot 11 having a machining tool.

The typical embodiment of the present invention was described above. A person skilled in the art could understand that the embodiment can be changed and various other changes, omissions, and additions may be made without departing from the scope of the present invention.

1. A robot control device that allows a robot to machine a workpiece based on graphic primitives indicating a machined part of an object, the graphic primitives being included in CAD data on a machining drawing of the object,
the robot control device comprising:
a database unit in which machining details and information on a machining tool corresponding to the machining details are stored in association with each other;
a graphic primitive selection unit that selects, from the CAD data, the graphic primitives having a tag indicating the machining details;
a tool data extraction unit that extracts, from the database unit, information on the machining tool associated with the machining details indicated by the tag attached to the graphic primitives selected by the graphic primitive selection unit; and
an operation planning unit that allows the robot to perform a machining operation according to the extracted information on the machining tool from the tool data extraction unit based on the graphic primitives selected by the graphic primitive selection unit.

2. The robot control device according to claim 1, further comprising a CAD device that is connected so as to communicate with the robot control device and creates and stores the CAD data on the machining drawing of the object,
the CAD device including a machining details input unit that attaches the tag indicating the machining details to the graphic primitives indicating the machined part of the object.

3. The robot control device according to claim 1, wherein the information on the machining tool includes a machining tool type corresponding to the machining details and restrictive conditions including at least one of a relative velocity, a position, and an orientation of the machining tool relative to the machined part.

4. A robot program generator that allows a robot to machine an object based on graphic primitives indicating a machined part of the object, the graphic primitives being included in CAD data on a machining drawing of the object,
the robot program generator comprising:
a database unit in which machining details and information on a machining tool corresponding to the machining details are stored in association with each other;
a graphic primitive selection unit that selects, from the CAD data, the graphic primitives having a tag indicating the machining details;
a tool data extraction unit that extracts, from the database unit, information on the machining tool associated with the machining details indicated by the tag attached to the graphic primitives selected by the graphic primitive selection unit; and
an operation planning unit that allows the robot to perform a machining operation according to the extracted information on the machining tool from the tool data extraction unit based on the graphic primitives selected by the graphic primitive selection unit.

5. The robot program generator according to claim 4, further comprising a CAD device that is connected so as to communicate with the robot program generator and creates and stores the CAD data on the machining drawing of the object,
the CAD device including a machining details input unit that attaches the tag indicating the machining details to the graphic primitives indicating the machined part of the object.

6. The robot program generator according to claim 4, wherein the information on the machine tool includes a machining tool type corresponding to the machining details and restrictive conditions including at least one of a relative velocity, a position, and an orientation of the machining tool relative to the machined part.
